(19) United States
(12) Patent Application Publication
(10) Pub. No.: US 2022/0383258 A1
(43) Pub. Date: Dec. 1, 2022

(54) TECHNOLOGICAL SUPPORT FOR COLLABORATIVE SONGWRITING AND RIGHTS REGISTRATION THEREFOR

(71) Applicant: SongHub LLC, Los Angeles, CA (US)

(72) Inventors: Steve Stewart, Los Angeles, CA (US); Joe Berman, Los Angeles, CA (US); Jean-Yves Martineau, Gatineau (CA)

(21) Appl. No.: 17/330,280

(22) Filed: May 25, 2021

(51) Int. Cl. G06Q 10/10; G06F 40/174; G10H 1/00

(52) U.S. Cl. CPC G06Q 10/103; G06F 40/174; G10H 1/0008; G10H 2240/175; G10H 2220/091; G10H 2210/105

(57) ABSTRACT

A facility providing technological support for the initiation, performance, and/or registration of a collaborative songwriting project is described.

### BACKGROUND

When a songwriter writes a song, it is common for him or her to register it with a performance rights organization. The performance rights organization handles details of licensing the song for certain purposes, collecting revenue on behalf of the songwriter for such uses as performing or otherwise using the song in public locations.

Songwriters often also file copyright registration applications for their songs with a government copyright office, either directly or through a performance rights organization.

While some musical compositions are written by a single person, many result from the collaboration of multiple songwriters. In registering compositions for both performance rights and copyright, it is typical for the songwriters to all be identified. In registering compositions for performance rights, it is common to further attribute a particular percentage of the songwriting credit to each of the songwriters.

### BRIEF DESCRIPTION OF THE DRAWINGS

FIG. 1 is a block diagram showing some of the components typically incorporated in at least some of the computer systems and other devices on which the facility operates.

FIG. 2 is an architecture drawing showing components of the facility.

FIG. 3 is a display diagram showing a sample display presented by the facility in some embodiments to provide a social networking dashboard for a first songwriter.

FIG. 4 is a display diagram showing a sample display presented by the facility in some embodiments to show the first songwriter's profile.

FIG. 5 is a display diagram showing a sample display presented by the facility in some embodiment to organize songwriters into genres in which they work.

FIG. 6 is a display diagram showing a sample display presented by the facility to list the songwriters in a particular genre.

FIG. 7 is a display diagram showing a sample display presented by the facility in some embodiments to show the profile of a second songwriter, such as one being investigated by the first songwriter for a collaboration.

FIG. 8 is a display diagram showing a sample display presented by the facility in some embodiments to show a message exchange between the first and second songwriters.

FIG. 9 is a flow diagram showing a process performed by the facility in some embodiments to operate a project in which two or more songwriters collaborate.

FIG. 10 is a display diagram showing a sample display presented by the facility in some embodiments to solicit additional information about an initiated project.

FIG. 11 is a display diagram showing a sample display presented by the facility in some embodiments to receive and display new messages for a participant in a project.

FIG. 12 is a display diagram showing a sample display presented by the facility in some embodiments to initiate the upload of a file—such as sound file, a textual lyrics file, or a sheet music file—to the project.

FIG. 13 is a display diagram showing a sample display presented by the facility in some embodiments to show the uploading of a file to a project.

FIG. 14 is a flow diagram showing a projects performed by the facility in some embodiments to document a file upload in a blockchain.

FIG. 15 is a data structure diagram showing a sample XML data structure generated by the facility in some embodiments to document the uploading of a first file to the project shown in FIG. 13.

FIG. 16 is a flow diagram showing a process performed by the facility in some embodiments to verify information about a file uploaded to a project.

FIG. 17 is a display diagram showing a sample display presented by the facility in some embodiments to reflect the uploading of a second file to the project.

FIG. 18 is a data structure diagram showing a sample XML data structure updated by the facility in some embodiments to document the uploading of the second file to the project shown in FIG. 17.

FIG. 19 is a display diagram showing a sample display presented by the facility in some embodiments to permit a project participant to submit a registration command for a project.

FIG. 20 is a flow diagram showing a process performed by the facility in some embodiments to perform automatic registration of an uploaded song.

FIG. 21 is a display diagram showing a sample display presented by the facility in order to obtain registration information in accordance with act 2001.

FIG. 22 is a display diagram showing a sample display presented by the facility in some embodiments to report that a registration request has been submitted for the project.

FIG. 23 is a display diagram showing an example display presented by the facility in some embodiments to report that registration with the performance rights organization is complete.

### DETAILED DESCRIPTION

The inventors have recognized significant disadvantages to conventional approaches to songwriter collaboration. First, the processes of identifying collaborators, communicating about the project, and exchanging contributions in the absence of special-purpose resources can be difficult and burdensome. Using ad-hoc methods can make collaboration take longer, be a less pleasant experience for the collaborators, extend how long a project takes, and negatively affect the quality of the resulting composition. As examples, conventionally, a songwriter seeking a collaborator may limit himself or herself only to a small number of other songwriter s/he has already met; may communicate about the project by telephone, leaving no persisting record of the contents of the communication; may exchange contributions as email attachments, making them difficult to find in cluttered email mailboxes, subject to accidental deletion, and consuming significant amounts of email mailbox storage capacity.

Further, conventional collaboration techniques do not produce reliable records of which collaborator contributed which contributions to the project. This makes it difficult to establish that any list of collaborators is complete and correct. It can also make it difficult to justify proposed splits of songwriting credit.

Also, conventionally, collaborators must take significant manual steps to register completed compositions with various registrars, including performing rights organizations and copyright registrars. These manual steps can take significant time and effort, and are subject to error.

In response to recognizing these disadvantages of conventional songwriting collaboration techniques, the inventors have conceived and reduced to practice a software and/or hardware facility for supporting collaborative songwriting (“the facility”).

In some embodiments, the facility provides a social networking platform for songwriters. In various embodiments, the social networking platform includes functionality for discovering songwriters or other artist with whom to collaborate; launching and interacting about songwriting projects; and exchanging contributions to the project, such as audio files, sheet music files, textual lyrics files, music authoring system files, etc.

In some embodiments, the facility provides a secure contribution documentation mechanism. For each contribution a collaborator makes to a songwriting project, the facility generates and publishes a blockchain record documenting the collaborator's contribution to the project. At times in the future, the published blockchain record can be used to prove that the collaborator made a contribution to the project at a particular date and time, and that the contribution had particular contents.

In some embodiments, the facility provides a mechanism for automatically registering the song produced by a collaboration project, such as with a performing rights organization, a governmental copyright registrar, and/or registrar of other types. In some embodiments, this involves collecting songwriting credit percentages for each collaborator, and obtaining explicit approval of these allocations from all of the collaborators.

By performing in some or all of these ways, the facility makes it easier to initiate and perform collaborative songwriting; makes it possible to establish which collaborator made what contributions to a project, protecting them from unfounded claims of credit from their collaborators and outside parties; and streamlines and protects from error the process of registering authored songs.

Also, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. In particular, in some embodiments, the facility eliminates the need to devote scarce email storage space to the exchange of large songwriting project contribution files.

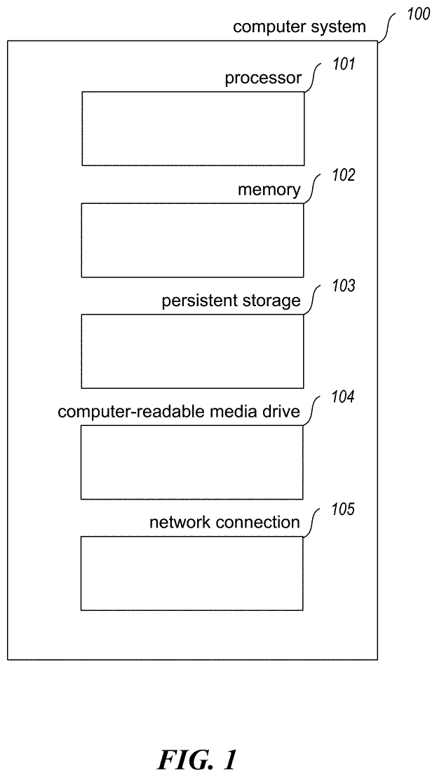

FIG. 1 is a block diagram showing some of the components typically incorporated in at least some of the computer systems and other devices on which the facility operates. In various embodiments, these computer systems and other devices 100 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a central processing unit (“CPU”) 101 for executing computer programs; a computer memory 102 for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

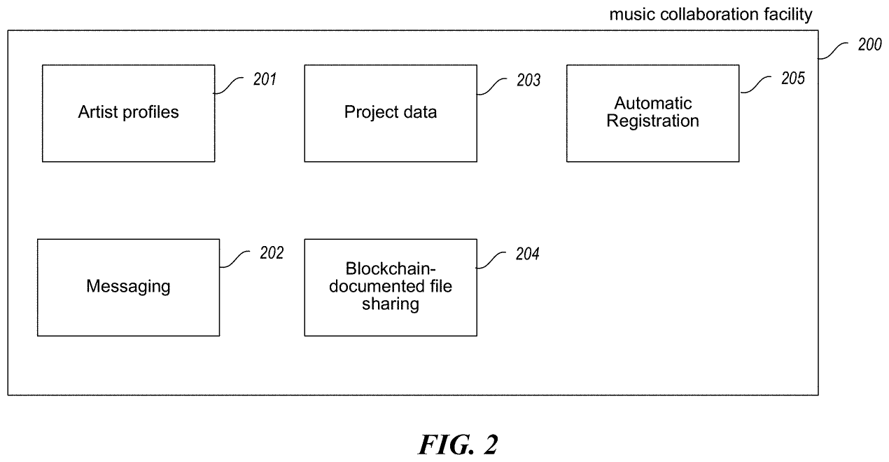

FIG. 2 is an architecture drawing showing components of the facility. The music collaboration facility 200 includes components for providing artist profiles 201, messaging among artists 202, data about music collaboration projects 203, file sharing as documented in blockchain entries 204, and automatic song registration 205.

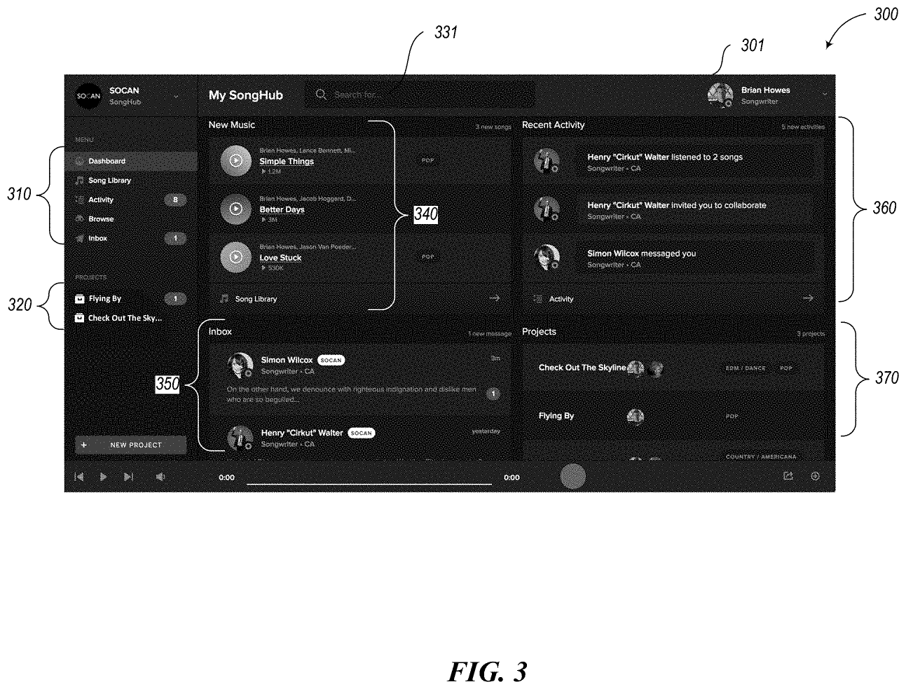

As described above. in some embodiments, the facility provides a social networking platform to support the collaboration of songwriters and other artists. FIG. 3 is a display diagram showing a sample display presented by the facility in some embodiments to provide a social networking dashboard for a first songwriter. The dashboard display 300 includes information 301 identifying the songwriter; links 310 to a variety of social networking resources provided to the artist; a list 320 of projects on which the first songwriter is presently collaborating; a search box 331 that the songwriter can use to search for content on the social network; a list 340 of songs, such as songs that the first songwriter has collaborated on, songs the first songwriter is interested in, etc.; an inbox 350 containing messages sent via the social network addressed to the first songwriter; a recent activity list 360 reflecting social network activity by or relating to the first songwriter; and a larger list 370 of the projects in which the first songwriter is collaborating.

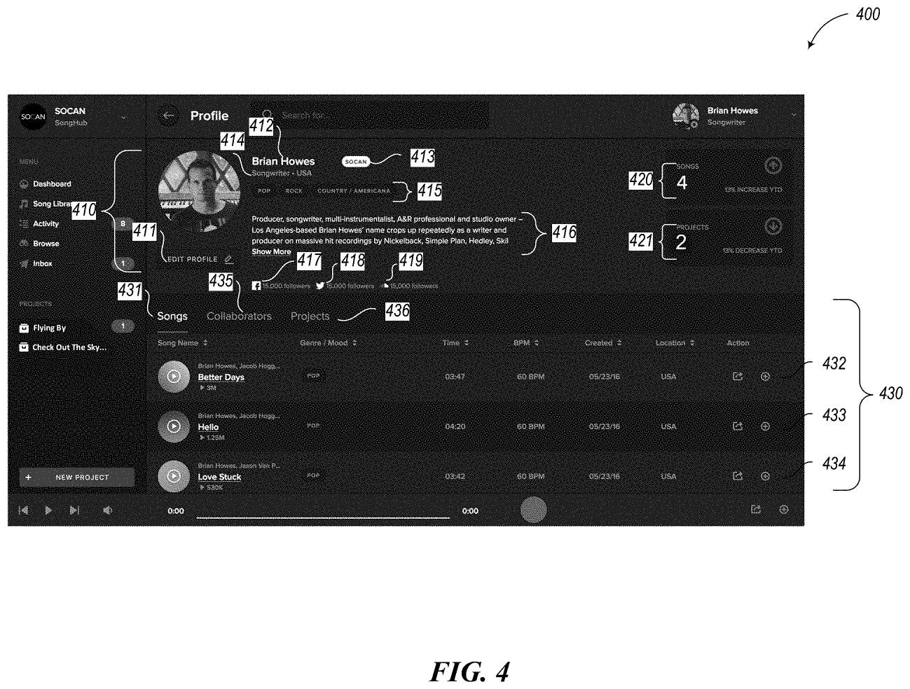

FIG. 4 is a display diagram showing a sample display presented by the facility in some embodiments to show the first songwriter's profile. In some embodiments, the facility presents the profile 400 in response to the first songwriter clicking on, touching, or otherwise activating the indication 301 of the first artist's identity shown in FIG. 3. The profile includes detailed profile information 410, including the songwriter's name 412; an indication 413 of the performance rights organization representing the first songwriter, here SOCAN, The Society of Composers, Authors, and Music Publishers of Canada; his role 414; music genres 415 in which he works; a narrative description 416; links 417-419 to the songwriter's presence on other social networking platforms; and a control 411 for revising this profile information. Also displayed is an indication 420 of the number of songs the songwriter has, and an indication 421 of the number of projects in which the songwriter is collaborating. The profile further includes a table 430 of songs contributed to by or otherwise relating to this songwriter, including songs 432-434. The user can select control 435 in order to list the songwriter's collaborators, or control 436 to list the songwriter's projects.

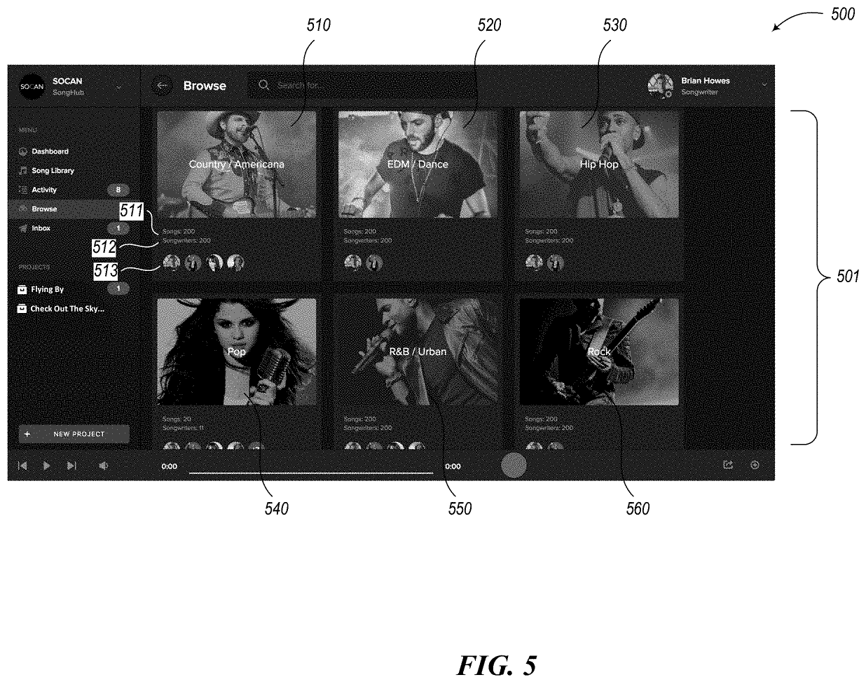

FIG. 5 is a display diagram showing a sample display presented by the facility in some embodiment to organize songwriters into genres in which they work. In some embodiments, the facility presents this display in response to the first songwriter selecting the Browse link among the links 310 shown in FIG. 3. The display 500 shows six musical genres 510, 520, 530, 540, 550, and 560. For each, it shows a number of songs 511, a number of songwriters 512, and the identity 513 of at least some of those songwriters.

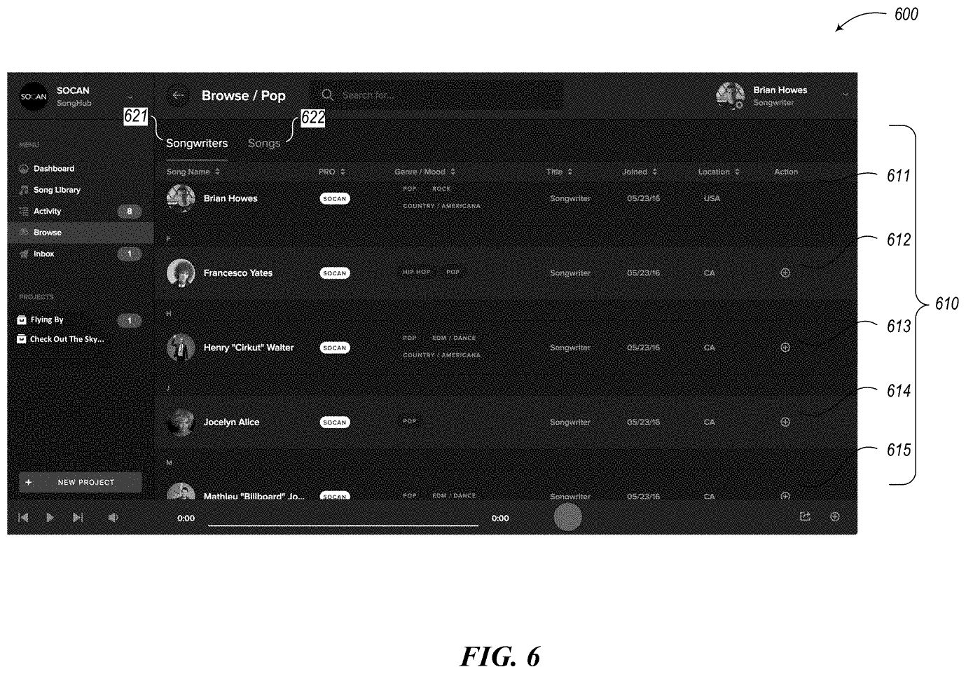

FIG. 6 is a display diagram showing a sample display presented by the facility to list the songwriters in a particular genre. In particular, the display 600 contains a list 610 of songwriters 611-615 in the pop genre. This can be displayed, for example, by selecting the pop genre photo shown in FIG. 5. The display also includes a songs control 622 that the user can select in order to display songs in the pop genre. Any of the listed songwriters can be selected in display 600 in order to display their profile.

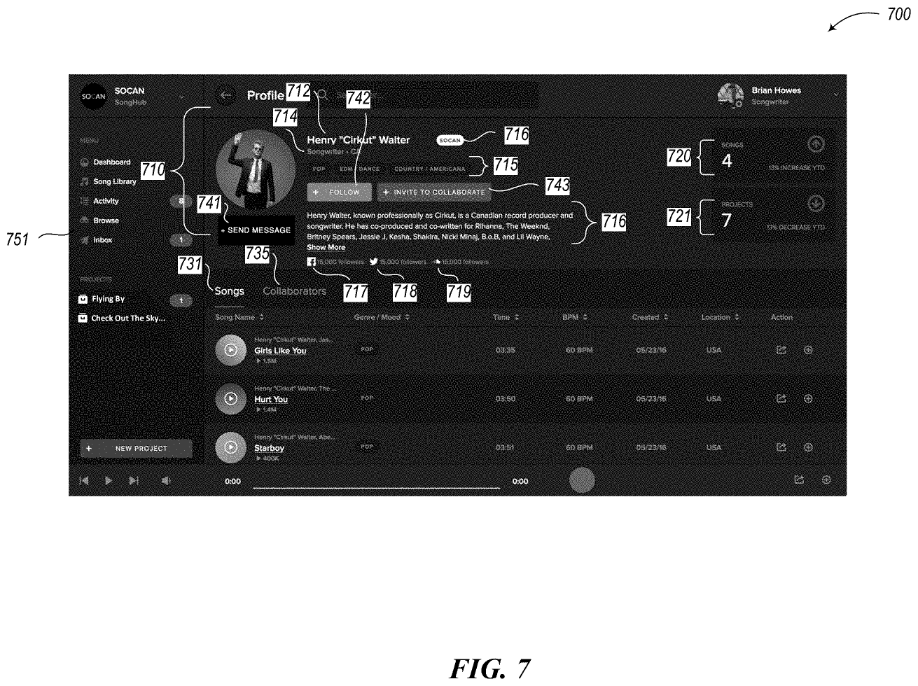

FIG. 7 is a display diagram showing a sample display presented by the facility in some embodiments to show the profile of a second songwriter, such as one being investigated by the first songwriter for a collaboration. In some embodiments, the facility presents this display in response to the first songwriter selecting songwriters 613 from the list 610 of songwriters shown in FIG. 6. The display 700 includes similar types of information 710 about the second songwriter, as well as information about the second songwriter's songs 731 and collaborators 735. In various embodiments (not shown), the facility provides a variety of discovery mechanism for identifying other artists with whom to collaborate, including browsing, searching, recommendations based on collaborative filtering and/or machine learning, third-party human recommendations, etc.

Additionally, display 700 includes controls that enable the first songwriter to interact with the second songwriter about the project on the social network. A send message control 741 permits the first songwriter to send a message to the second songwriter; a follow control 742 enables the first songwriter to follow the activities of the second songwriter; and an invite to collaborate control 743 enables the first songwriter to invite the second songwriter to collaborate on a project.

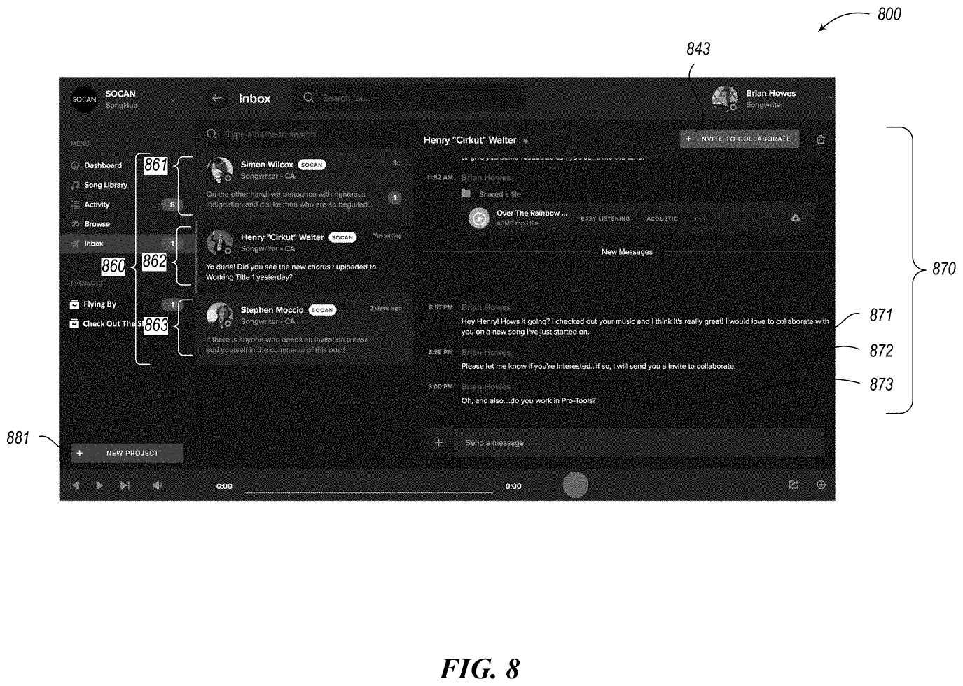

FIG. 8 is a display diagram showing a sample display presented by the facility in some embodiments to show a message exchange between the first and second songwriters. In particular, the display 800 shows the first songwriter, Brian Howes's view of messages exchanged with the second songwriter, Henry “Cirkut” Walter. In some embodiments, this exchange of messages was begun by the first songwriter selecting the send message control 741 for the second songwriter in the second songwriter's profile shown in FIG. 7. Those messages 870 include messages 871-873. The display also includes a list 860 of the first songwriter's songwriter correspondents 861, 862, and 863. The first songwriter can select any of these songwriter correspondents to display a similar message list showing messages exchanged with that correspondent. The display also includes a new project control 881 that the first songwriter can activate to create a new project, as well as an invite to collaborate control 843 that the first songwriter can activate to invite to collaborate with him, and thus initiate a new project together.

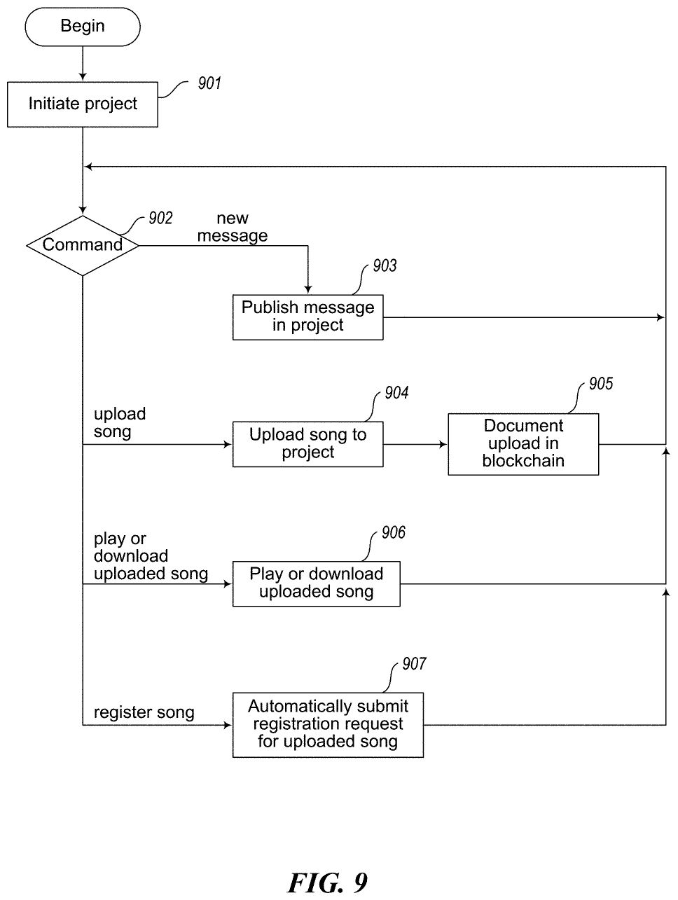

FIG. 9 is a flow diagram showing a process performed by the facility in some embodiments to operate a project in which two or more songwriters collaborate. In act 901, the facility initiates a project, such as in response to the first songwriter's selection of the invite to collaborate control 843 with respect to the second songwriter. In some embodiments, as part of act 901, the facility collects information about the project, and stores it among the project data 203 shown in FIG. 2.

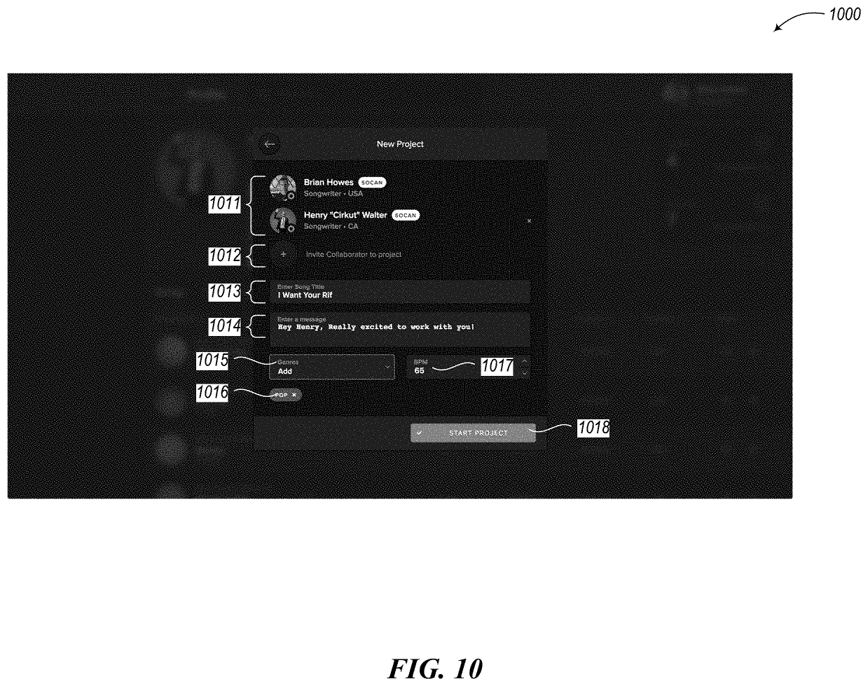

FIG. 10 is a display diagram showing a sample display presented by the facility in some embodiments to solicit additional information about an initiated project. The display 1000 includes information 1011 identifying the project's participants; a control 1012 for adding one or more additional collaborators to the project; a control 1013 for entering a title for the project; a control 1014 for entering a message to be exchanged among the project's collaborators; a control 1015 for adding genres, such as the pop genre 1016, to the project; a control 1017 for adding a beats-per-minute level to the project; and a control 1018 for starting the project.

Returning to FIG. 9, in act 902, the facility receives a command or other input from one of the project's participants with respect to the project, and branches based upon the type of the command: if the command is a new message command, then the facility continues in act 903; if the command is an upload song command, then the facility continues in act 904; if the command is a play or download uploaded song command, then the facility continues in act 906; and if the command is a register song command, then the facility continues in act 907. In act 903, where the received command is a command for sending a new message in the project, the facility receives the new message, and publishes the message as part of the project. After act 903, the facility continues in act 902 to receive the next command.

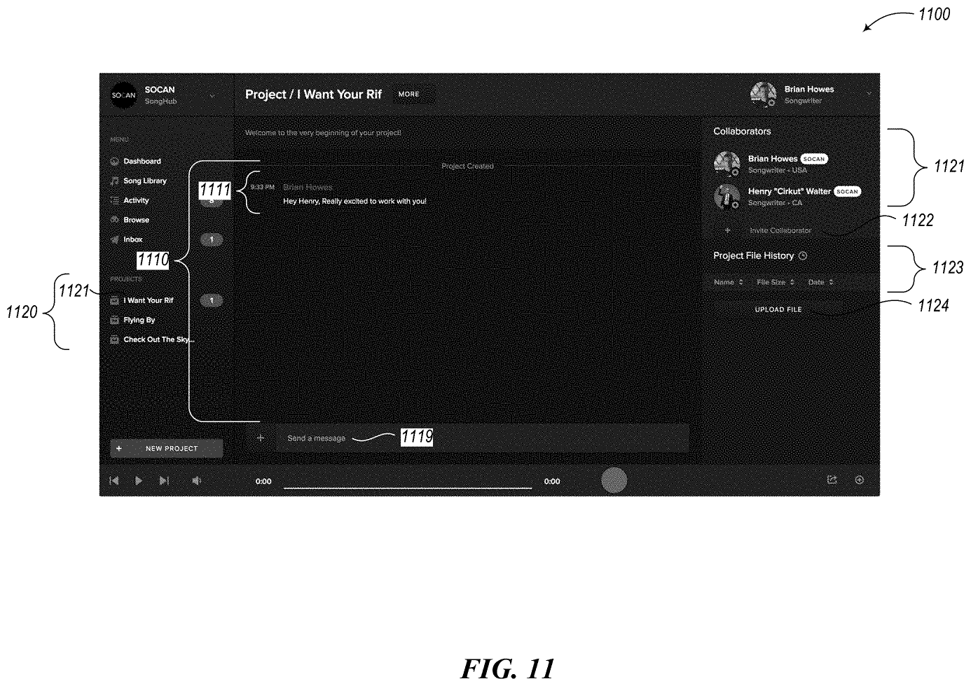

FIG. 11 is a display diagram showing a sample display presented by the facility in some embodiments to receive and display new project messages for a participant in a project. The display 1100 includes an identification at the top of the new project, “I Want Your Rif” which is now listed as entry 1121 in project list 1120. The display also includes list 1121 of the project's collaborators; a control 1122 for inviting an additional collaborator; an empty project file history 1123, indicating that no file has yet been uploaded to the project; and an upload file control 1124 for uploading a file to the project. The display further contains a list 1110 of the messages exchanged as part of the project by its collaborators, which presently contains a single message 1111 from the first songwriter, Brian Howes. The display also includes a control 1119 for sending a new message as part of the project.

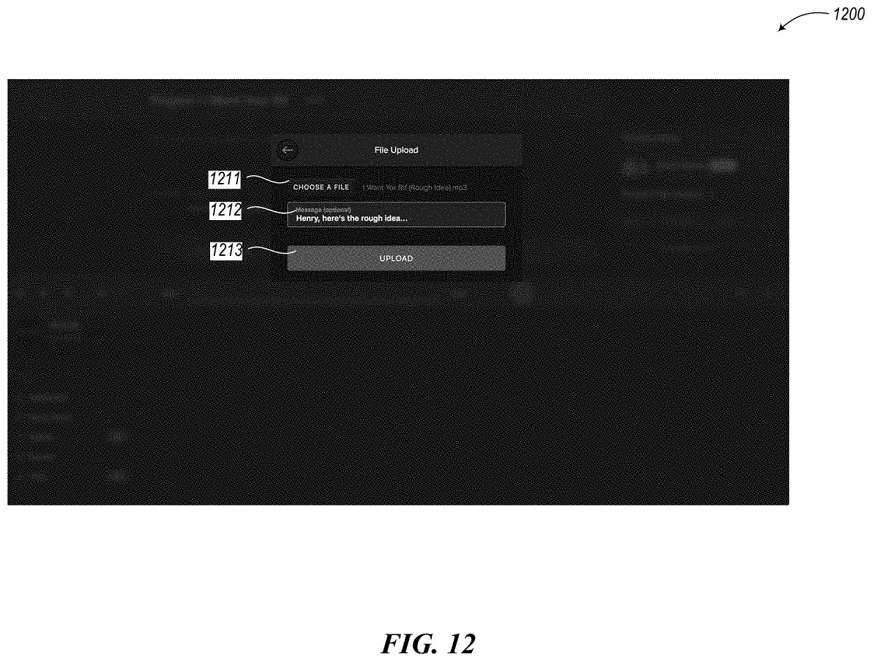

Returning to FIG. 9, if the received command is an upload song command, in act 904 uploads the song to the project. FIG. 12 is a display diagram showing a sample display presented by the facility in some embodiments to initiate the upload of a file—such as sound file, a textual lyrics file, or a sheet music file—to the project. The display 1200 includes a control 1211 for choosing a file to upload; a control 1212 for entering a message describing the file being uploaded; and a control 1213 for uploading this file with this message.

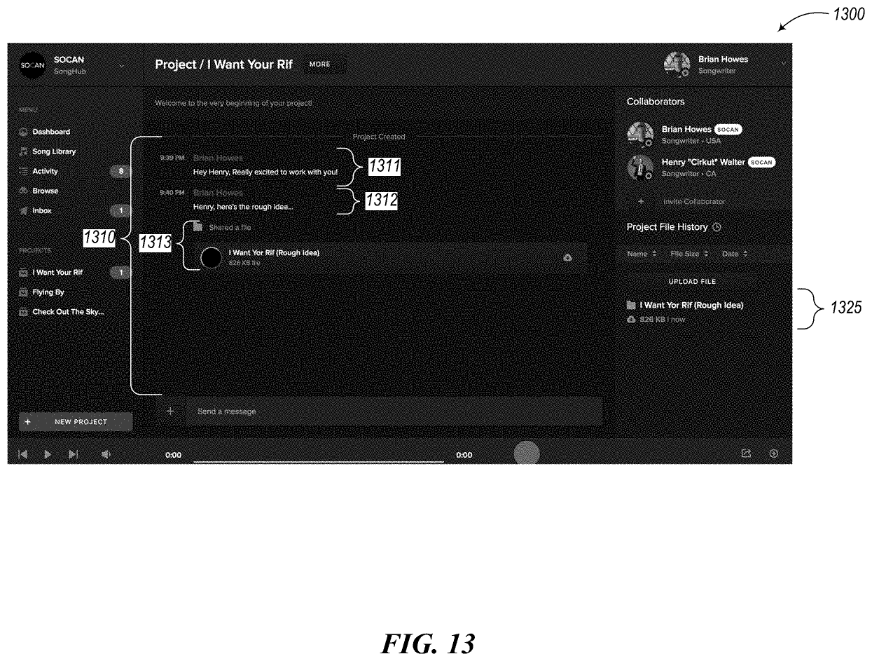

FIG. 13 is a display diagram showing a sample display presented by the facility in some embodiments to show the uploading of a file to a project. In the display 1300, a new entry 1313 can be seen in the message list 1310 for the project corresponding to the file upload. Additionally, a message 1312 has been added to the message list that corresponds to the message input into control 1212, shown in FIG. 12 part of the file upload. Further, the project file history now contains an entry 1325 corresponding to the file upload. In some embodiments, the user can select either of the indications 1313 and 1325 of the uploaded file to interact with it, such as by playing it, downloading it, displaying metadata or other additional information about it, etc.

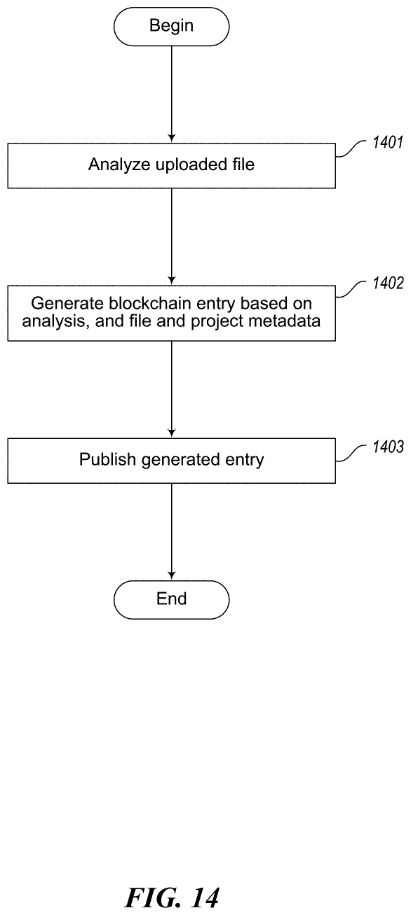

Returning to FIG. 9, after act 904, in act 905, the facility documents the uploaded song in a blockchain, as described in more detail below in connection with FIGS. 14-18.

FIG. 14 is a flow diagram showing a projects performed by the facility in some embodiments to document a file upload in a blockchain. In act 1401, the facility analyzes the uploaded file. In act 1402, the facility generates a blockchain entry based on this analysis, as well as file and project metadata. In act 1403, the facility publishes the generated entry to a blockchain. After act 1403, this process concludes.

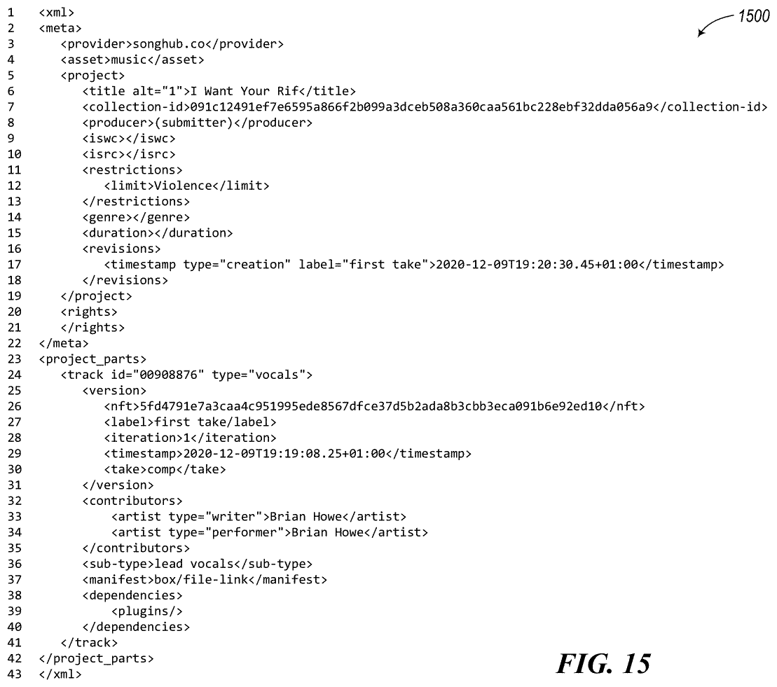

FIG. 15 is a data structure diagram showing a sample XML data structure generated by the facility in some embodiments to document the uploading of a first file to the project shown in FIG. 13. In some embodiments, some or all of this data structure are stored persistently by the facility, and portions of it are written to the blockchain at appropriate times. The data structure 1500 comprises lines 1-45 which contain information encoded from the content of the file, the identity of the project, and various other information about the project. Lines 1-43 represent the project as a whole at a time corresponding to shortly after the first file upload.

Lines 2-22 contain metadata for the project, as follows: Line 3 identifies a provider used by the artists to construction documents the project. When six contains the title of the project. Line 7 contains a collection ID for the project. Line 16-18 contain a list of editorial revisions that have been made to the project by its producer. In particular, line 17 documents a revision named “first take” in which the producer created the project. Line 17 includes a timestamp at which this occurred.

Lines 23-42 contain information about uploaded data used in the project. Lines 24-41 describe a first part of the project identified in line 24 by a particular track ID and a “vocals” type. The single existing version of this track/part, corresponding to the file uploaded in FIG. 13, is described in lines 25-31. Line 26 contains a hash or checksum on the contents of the first uploaded file usable to determine whether a file asserted to be the first uploaded file has the same contents. Line 27 indicates that this version is part of the “first take” revision of the project. Line 28 indicates that this version is the first iteration of this track. Line 29 contains a timestamp identifying the time at which the first file upload occurred. Line 30 indicates the nature of the version of the track/part. Line 32-35 identifies contributors to the track/part. In particular, Brian Howe is identified as the only writer and the only performer of the track/part, as he created the first version of the track/part before Henry Walker began participating. Line 36 identifies the musical nature of the track/part. Line 37 identifies a manifest for the track/part. In some embodiments, the facility adds lines 26, 28, and 29 to the data structure and stores them in the blockchain in response to the first file upload.

In some embodiments, the facility adds lines 17 and 27 to the data structure and stores them in the blockchain in response to creating the first revision. In some embodiments, in response to creating the first revision, rather than storing only line 27 in the blockchain, the facility stores lines 25-31 in the blockchain.

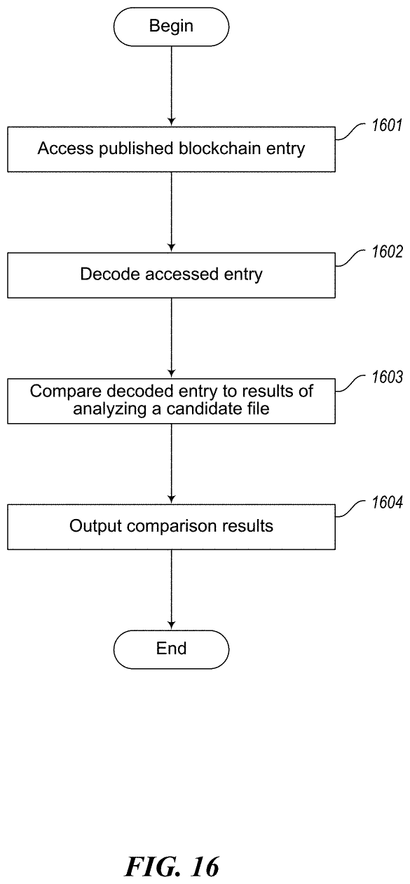

One of the benefits of documenting each file upload to the project is that the contents of the file and information about its uploading can be verified based upon the published blockchain entry. FIG. 16 is a flow diagram showing a process performed by the facility in some embodiments to verify information about a file uploaded to a project. In act 1601, the facility accesses a published blockchain entry. In act 1602, the facility decodes the accessed entry. In act 1603, the facility compares the decoded entry to results of analyzing a candidate file. In act 1604, the facility outputs the comparison results. If these comparison results indicate that the compared versions of the entry match, then the candidate file is verified as having been uploaded as part of a songwriting project. After act 1604, this process concludes.

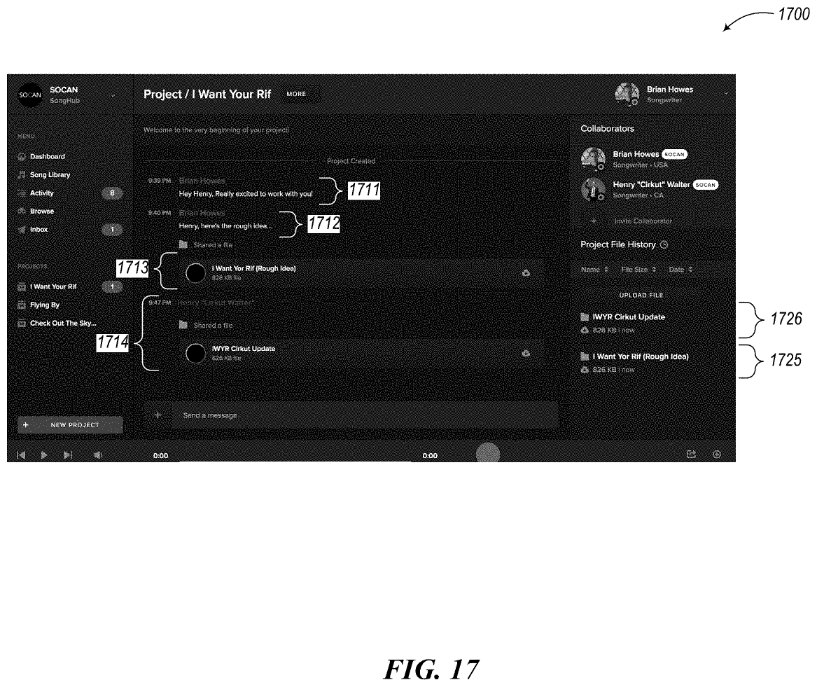

Over the course of the project, the participants can upload additional files. FIG. 17 is a display diagram showing a sample display presented by the facility in some embodiments to reflect the uploading of a second file to the project. By comparing the display 1700 to display 1300 shown in FIG. 13, it can be seen that new indications 1714 and 1726 of this new uploaded file, “IWYR Cirkut Update” have been added to the display.

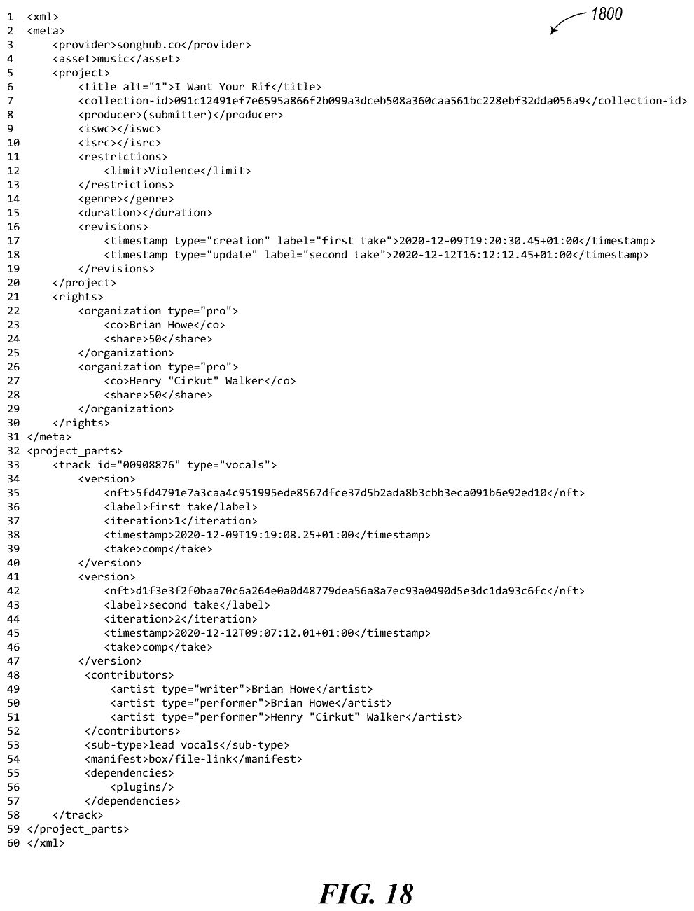

FIG. 18 is a data structure diagram showing a sample XML data structure updated by the facility in some embodiments to document the uploading of the second file to the project shown in FIG. 17.

By comparing data structure 1800 to data structure 1500 shown in FIG. 15, the details of the facility's updating of the data structure can be seen. In particular, the facility has added lines 18, 22-29, 41-47, and 51, as follows. By adding line 18, the facility has documented a second editorial revision made to the project by its producer to incorporate the second-uploaded file. Line 18 records that time at which the editorial revision was created, its name “second take”, and the fact that the revision is an update.

By adding lines 22-29, the facility has recorded the credit allocation arrived at by the artists. In particular, lines 22-25 indicate a 50% share of artist credit for Brian Howe, in lines 26-29 indicated 50% share of artist credit for Henry Walker.

By adding lines 41-47, the facility has made a record of the second file upload, corresponding to a second version of the existing track/part. It can be seen that line 42 contains a hash on the contents of the second-uploaded file; line 43 indicates that this version is part of the “second take” revision; and line 45 contains a timestamp identifying the time at which the upload occurred.

By adding line 51, the facility documented that, by virtue of working on the second-uploaded version of the track/part, Henry Walker has been added as a performer on this track. In some embodiments, the facility adds lines 42, 44, and 49 to the data structure and stores them in the blockchain in response to the second file upload.

In some embodiments, the facility adds lines 18 and 43 to the data structure and stores them in the blockchain in response to creating the second revision. In some embodiments, in response to creating the second revision, rather than storing only line 43 in the blockchain, the facility stores lines 41-47 in the blockchain.

In some embodiments, the facility adds lines 22-29 to the data structure and stores them in the blockchain in response to determining the credit allocation. This credit allocation documentation of the credit allocation is enforced via smart contract.

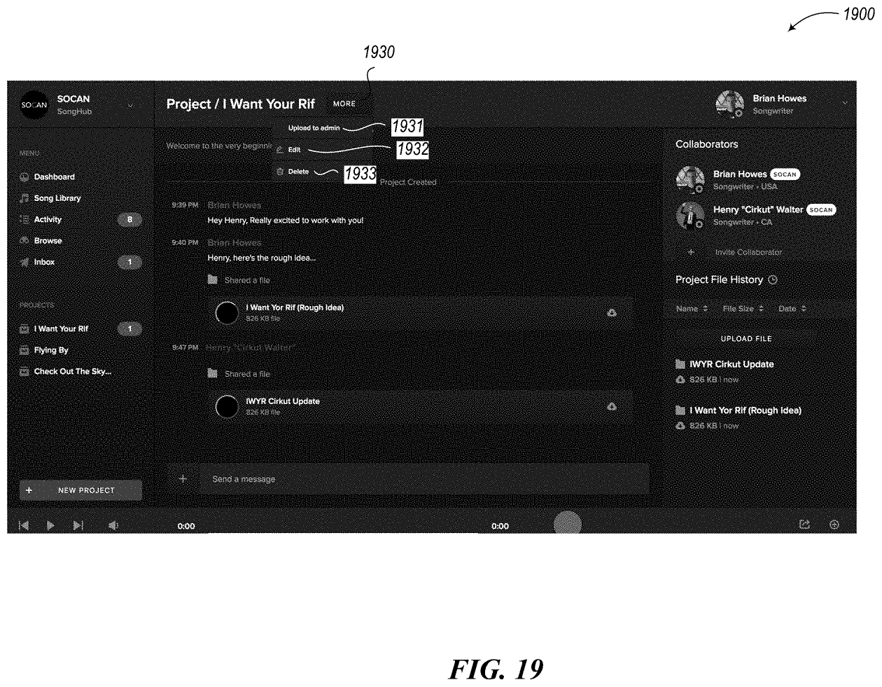

Returning to FIG. 9, in act 907, where the command is to register a song, the facility automatically submits a registration request for one of the versions of the song that have been uploaded to the project. After act 907, the facility continues act 902 to receive the next command. This process is described further below in connection with FIGS. 19-23.

FIG. 19 is a display diagram showing a sample display presented by the facility in some embodiments to permit a project participant to submit a registration command for a project. In the display 1900, a user can select a control 1930 in order to display a project actions menu, which includes a control 1931 for performing automatic registration, a control 1932 for editing the project, and a control 1933 for deleting the project. To perform an automatic registration, the user selects control 1931.

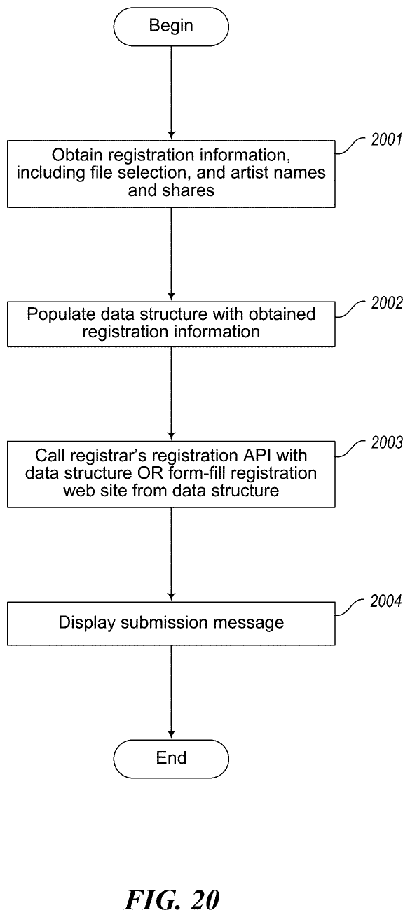

FIG. 20 is a flow diagram showing a process performed by the facility in some embodiments to perform automatic registration of an uploaded song. In act 2001, the facility obtains registration information for the song, including selection of the file containing the song and the identity of the artists and their authorship shares.

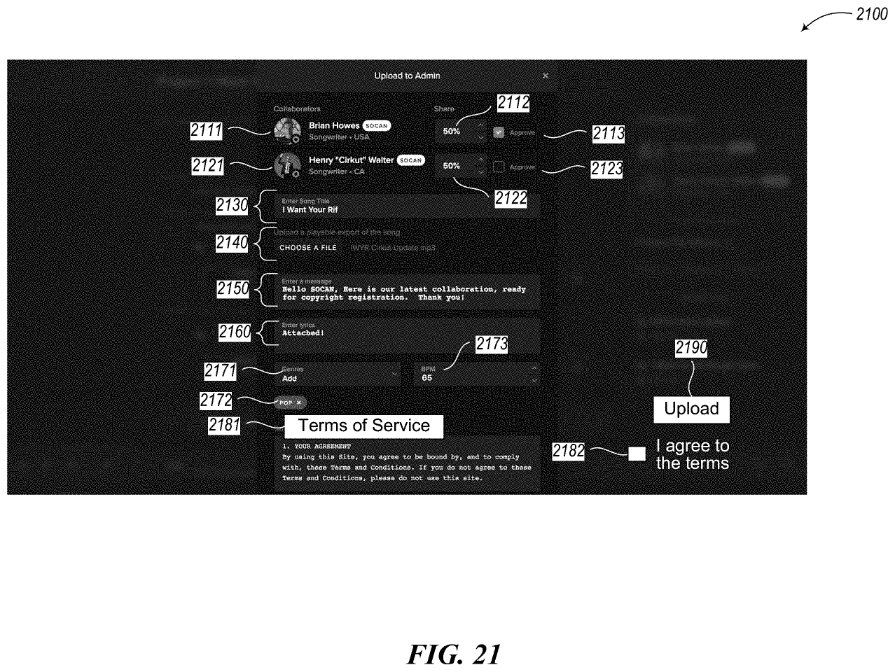

FIG. 21 is a display diagram showing a sample display presented by the facility in order to obtain registration information in accordance with act 2001. The display 2100 includes indications 2111 and 2121 of the identity of the songwriters who collaborated on the project; controls 2112 and 2122 for setting the authorship shares of each contributor; and author approval controls 2113 and 2123, which can be activated by each of the collaborators who approve their share of the authorship credit. The display also includes a control 2130 for entering a song title; a control 2140 for choosing the uploaded file that is to be registered; a control 2150 for entering a registration message; a control 2116 for entering lyrics of the song; a control 2171 for adding genres for the song, such as the pop genre 2172; control 2173 for entering a beats-per-minute level of the song; and terms of service 2181 relating to registration. In order to complete the registration, the user checks a check box 2182 indicating that they agree to the display terms, and activates an upload control 2190 to perform the registration.

Returning to FIG. 20, in act 2002, the facility populates a data structure with the registration information obtained in act 2001. In act 2003, the facility provides to a registrar the contents of the data structure populated in act 2002, such as calling a registration API provided by the registrar with the data structure, or by performing automatic form fill of the appropriate page of the registrar's registration website. In some embodiments, the facility automatically selects the performance rights organization or other registrar to which the registration request is submitted based upon the performance rights organization representing the project participants, and looks up information it maintains on the registration process to use for that registrar. In some embodiments, the facility performs registration for the project with multiple registrars, such as a performing rights organization and one or more governmental copyright registrars, such as the United States Library of Congress. In act 2004, the facility displays a submission message, indicating that a registration request has been submitted for the song. After act 2004, this process concludes.

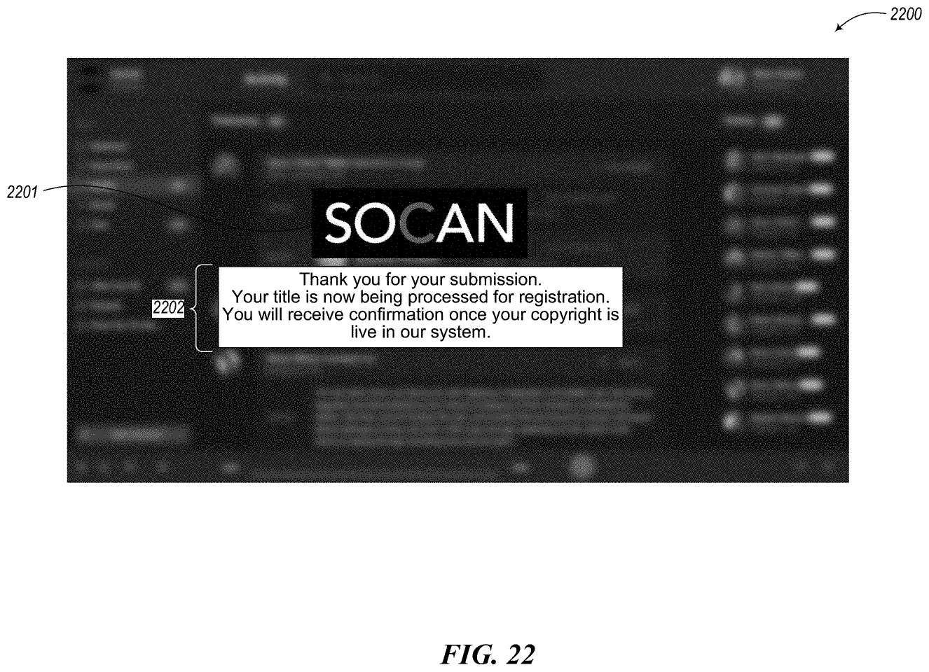

FIG. 22 is a display diagram showing a sample display presented by the facility in some embodiments to report that a registration request has been submitted for the project. The display 2200 includes an indication 2201 of the performance rights organization to which the registration request was submitted, and a message 2202 about the status of the submission.

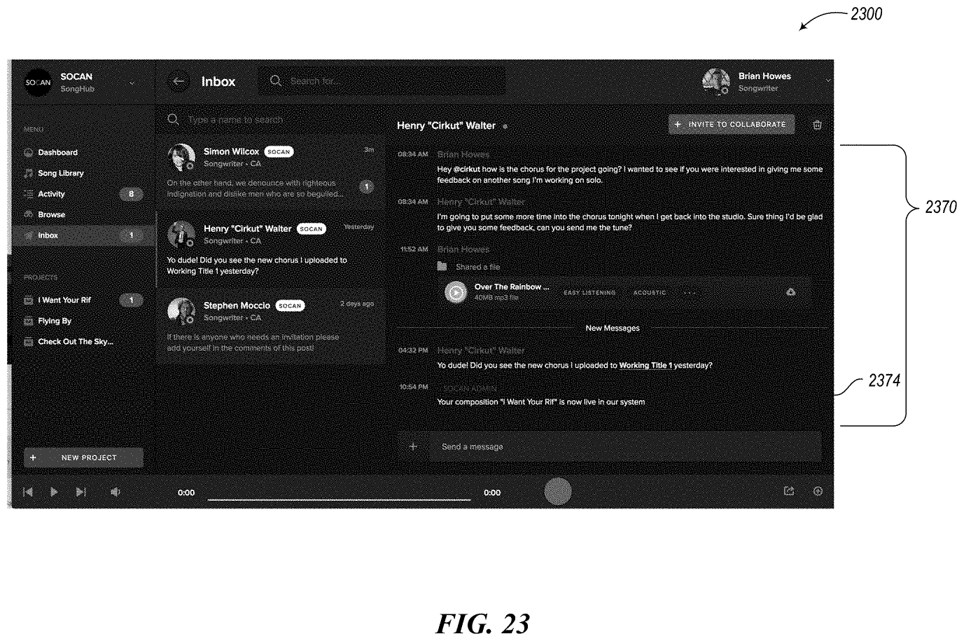

FIG. 23 is a display diagram showing an example display presented by the facility in some embodiments to report that registration with the performance rights organization is complete. In particular, display 2300 includes a message list 2370 and a message 2374 indicating that the “I Want Your Rif” registration has been completed.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method in a computing system for conducting a collaborative songwriting project, comprising:
operating a collaborator discovery mechanism on behalf of a first user;
receiving input from the first user selecting for participation in the songwriting project a second user identified by collaborator discovery mechanism;
operating a communication mechanism providing communication about the project between the first and second users;
for each of a plurality of musical resources:
receiving the musical resource from the first user or the second user;
persistently storing the contributed musical resource in a manner that makes it accessible to the first and second users;
generating a blockchain entry documenting the contribution of the musical resource to the project;
publishing the generated blockchain entry; and
automatically submitting a distinguished one of the stored musical resources, along with information about the project, to a registrar.

2. The method of claim 1 wherein the registrar is a copyright registrar, and the submitted information about the project includes identifying information for the first and second users.

3. The method of claim 1 wherein the registrar is a performance rights organization, and the submitted information about the project includes identifying information for the first and second users and a songwriting credit percentage for each of the first and second users.

4. The method of claim 3 wherein the discovery mechanism, communication mechanism, and receiving are all performed via a common user interface,
the method further comprising, via the common user interface, accessing information describing royalty collection by the performance rights organization on behalf of the project.

5. The method of claim 3 wherein the discovery mechanism, communication mechanism, and receiving are all performed via a common user interface,
the method further comprising, via the common user interface, accessing information describing royalty collection by the performance rights organization on behalf of the first user.

6. The method of claim 1 wherein the automatic submission comprises calling an application programming interface exposed by the registrar.

7. The method of claim 1 wherein the automatic submission comprises automatically filling a web-based registration form made available by the registrar.

8. The method of claim 1 wherein the discovery mechanism, communication mechanism, and receiving are all performed via a common user interface.

9. One of more instances of computer-readable media collectively having contents configured to cause a computing system to perform a method for conducting a collaborative songwriting project between first and second users, the method comprising:
via a common user interface:
operating a communication mechanism providing communication about the project between the first and second users;
for each of a plurality of musical resources:
receiving the musical resource from the first user or the second user;
for each of the received musical resources, persistently storing the received musical resource in a manner that makes it accessible to the first and second users.

10. The one of more instances of computer-readable media of claim 9, the method further comprising:
via the common user interface, receiving a request from the first or second user to download a distinguished one of the stored musical resources; and
in response to receiving the request, downloading the distinguished musical resource the user from whom the request was received.

11. The one of more instances of computer-readable media of claim 9, the method further comprising:
for each of the plurality of musical resources:
generating a blockchain entry documenting the contribution of the musical resource to the project; and
publishing the generated blockchain entry.

12. The one of more instances of computer-readable media of claim 9, the method further comprising:
receiving a validation candidate music resource;
accessing the published blockchain entry;
analyzing the accessed blockchain entry to determine whether it documents contribution of a music resource matching the candidate music resource;
if it is determined that the blockchain entry documents contribution of a music resource matching the candidate music resource, extracting contribution information for the music resource; and
generating output validating the validation candidate, and communicating at least a portion of the extracted contribution information.

13. The one of more instances of computer-readable media of claim 12 wherein the extracted contribution information communicated by the generated output comprises contributor identity and contribution time.

14. The one of more instances of computer-readable media of claim 12 wherein the extracted contribution information communicated by the generated output comprises information describing the project.

15. The one of more instances of computer-readable media of claim 9, the method further comprising:
automatically submitting a distinguished one of the stored musical resources, along with information about the project, to a registrar.

16. The one of more instances of computer-readable media of claim 9 wherein the registrar is a copyright registrar, and the submitted information about the project includes identifying information for the first and second users.

17. The one of more instances of computer-readable media of claim 9 wherein the registrar is a performance rights organization, and the submitted information about the project includes identifying information for the first and second users and a songwriting credit percentage for each of the first and second users.

18. One or more instances of computer-readable media collectively storing a blockchain, the stored blockchain comprising a distinguished blockchain entry data structure published as part of the blockchain, the distinguished blockchain entry data structure comprising:
a representation of the contents of a music resource; and
information identifying a contributor of the music resource.

19. The one of more instances of computer-readable media of claim 18 wherein the distinguished blockchain entry data structure further comprises a time at which the music resource was contributed.

20. The one of more instances of computer-readable media of claim 18 wherein the distinguished blockchain entry data structure further comprises information identifying a collaborative songwriting project to which the music resource was contributed.

21. The one of more instances of computer-readable media of claim 18 wherein the representation of the contents of the music resource is a hash on the contents of the music resource.

22. The one of more instances of computer-readable media of claim 18 wherein the blockchain is a cryptocurrency blockchain.

23. A computing system, comprising:
one or more processors; and
one or more memories collectively having contents to cause the one or more processors to perform a method, the method comprising:
accessing a song produced in a collaborative songwriting project; and
automatically submitting the song, along with information about the project, to a registrar.

24. The computing system of claim 23 wherein the registrar is a copyright registrar, and the submitted information about the project includes identifying information for participants in the project.

25. The computing system of claim 23 wherein the registrar is a performance rights organization, and the submitted information about the project includes identifying information for participants in the project and a songwriting credit percentage for each of the participants.

26. The computing system of claim 25 wherein the method further comprises:
receiving input specifying an allocation of songwriting credit across the participants; and
for each of the participants, receiving approval of the allocation specified by the received input.

27. The computing system of claim 23 wherein the automatic submission comprises calling an application programming interface exposed by the registrar.

28. The computing system of claim 23 wherein the automatic submission comprises automatically filling a web-based registration form made available by the registrar.
